(19) United States
(12) Patent Application Publication
(10) Pub. No.: US 2022/0156581 A1
(43) Pub. Date: May 19, 2022

(54) SYSTEMS AND METHODS FOR REINFORCED HYBRID ATTENTION FOR MOTION FORECASTING

(71) Applicant: Honda Motor Co., Ltd., Tokyo (JP)

(72) Inventors: Jiachen LI, Albany, CA (US); Chiho CHOI, San Jose, CA (US)

(21) Appl. No.: 17/173,460

(22) Filed: Feb. 11, 2021

Related U.S. Application Data
(60) Provisional application No. 63/113,668, filed on Nov. 13, 2020.

(51) Int. Cl. G06N 3/08; G06N 3/04

(52) U.S. Cl. CPC G06N 3/08; G06N 3/04

(57) ABSTRACT

Systems and methods for reinforced hybrid attention for motion forecasting are provided. According to one embodiment, a system for reinforced hybrid attention for motion forecasting is provided. The system includes a sensor module, a hard attention module, a soft attention module, and a motion module. The sensor module receives patio-temporal historical observations associated at least one element in an environment. The hard attention module selects information from the spatio-temporal historical observations associated with the at least one element based on a reinforcement learning model. The soft attention generates ranked information by applying attention weights to the selected information. The motion module generates motion predictions based on the ranked information.

### RELATED APPLICATIONS

This application claims priority to U.S. Provisional Patent Application entitled “SYSTEMS AND METHODS FOR REINFORCED HYBRID ATTENTION FOR MOTION FORECASTING,” Ser. No. 63/113,668 (Attorney Docket No. 49258), filed on Nov. 13, 2020; the entirety of the above-noted application is incorporated by reference herein.

### BACKGROUND

In recent years, motion forecasting has been widely studied in various domains, such as physical systems, human skeletons, and multi-agent interacting systems (e.g. traffic participants, sports players, etc.). In the past, motion forecasting has been performed based on observation. However, the observations are typically treated as though they have the same level of significance in all situations. For example, when changing lanes on a freeway, a host vehicle may collect observations regarding proximate vehicles traveling in the same longitudinal direction on the highway as the host vehicle. The host vehicle may also collect information regarding additional vehicles moving in an opposite longitudinal direction compared to the host vehicle and separated from the host vehicle by a barrier. Still the collected observations regarding both the proximate vehicles and the additional vehicles may be used to forecast the motions affecting the host vehicle because all of the observations are treated as though they are equally significant, even if those observations are irrelevant to the motion of the host vehicle.

To address irrelevant observations being treated with equal significance as relevant observations, existing systems predefine a fixed number of elements to include, thereby arbitrarily limiting the system despite the context.

### BRIEF DESCRIPTION

According to one embodiment, a system for reinforced hybrid attention for motion forecasting is provided. The system for reinforced hybrid attention for motion forecasting is provided. The system includes a sensor module, a hard attention module, a soft attention module, and a motion module. The sensor module receives spatio-temporal historical observations associated at least one element in an environment. The hard attention module selects information from the spatio-temporal historical observations associated with the at least one element based on a reinforcement learning model. The soft attention generates ranked information by applying attention weights to the selected information. The motion module generates motion predictions based on the ranked information.

According to another embodiment, a method for reinforced hybrid attention for motion forecasting is provided. The method includes receiving spatio-temporal historical observations associated at least one element in an environment. The method also includes selecting information from the spatio-temporal historical observations associated with the at least one element based on a reinforcement learning model. The method further includes generating ranked information by applying attention weights to the selected information. The method yet further includes generating motion predictions based on the ranked information.

According to yet another embodiment, a non-transitory computer readable storage medium storing instructions that, when executed by a computer having a processor, cause the computer to perform a method for reinforced hybrid attention for motion forecasting. The method includes receiving spatio-temporal historical observations associated at least one element in an environment. The method also includes selecting information from the spatio-temporal historical observations associated with the at least one element based on a reinforcement learning model. The method further includes generating ranked information by applying attention weights to the selected information. The method yet further includes generating motion predictions based on the ranked information.

### BRIEF DESCRIPTION OF THE DRAWINGS

FIG. 1 is an exemplary operating environment of a system for reinforced hybrid attention for motion forecasting, according to one aspect.

FIG. 2 is an exemplary vehicular embodiment for a system for reinforced hybrid attention for motion forecasting, according to one aspect.

FIG. 3 is an exemplary process flow of a method for reinforced hybrid attention for motion forecasting, according to one aspect.

FIG. 4 is an exemplary graphical representation of a framework for a system for reinforced hybrid attention for motion forecasting, according to one aspect.

FIG. 5 is another exemplary process flow of a method for reinforced hybrid attention for motion forecasting, according to one aspect.

FIG. 6 is an illustration of an example computer-readable medium or computer-readable device including processor-executable instructions configured to embody one or more of the provisions set forth herein, according to one aspect.

### DETAILED DESCRIPTION

As discussed above, predicting future state sequences based on historical spatio-temporal observations is complicated by the different levels of significance of the historical spatio-temporal observations. Moreover, the key information of the historical spatio-temporal observations may be varying as the situation evolves. The systems and methods provided herein select information from the historical spatio-temporal observations based on either spatial relations or temporal dependencies.

In the freeway scenario, a host vehicle may collect historical spatio-temporal observations regarding proximate vehicles traveling in the same longitudinal direction on the highway as a host vehicle. The host vehicle may also collect historical spatio-temporal observations regarding additional vehicles moving in an opposite longitudinal direction compared to the host vehicle and separated from the host vehicle by a barrier. Accordingly, the host vehicle receives historical spatio-temporal observations regarding both the proximate vehicles and the additional vehicles.

Turning to a human motion embodiment, it may motions of one or more humans may be observed. For example, the historical spatio-temporal observations may include the motions of a human as well as other elements, such as joint locations and relative angles of limbs.

To select information from the historical spatio-temporal observations, the systems and methods herein employ a hybrid attention mechanism. Specifically, both soft attention and hard attention may be used. The soft attention may be performed by applying a score function to input features followed by a softmax function to obtain the attention weights in the range of [0, 1]. These operations are fully differentiable which may be trained by gradient based back propagation with typical gradient-based optimizers. The hard attention may be performed to exclude irrelevant or unimportant elements. For example, suppose that the softmax function assigns non-zero attention weights to the irrelevant or unimportant elements, which dilutes the attention given to the truly significant information. The hard attention mechanism may cause a forecasting model to discard the irrelevant or unimportant elements and reduce redundancy.

Using multiple attention mechanisms allow for a complete set of historical spatio-temporal observations with a varying number of elements to be used as opposed to existing methods that predefine a fixed number of elements to model. Continuing the example from above, the motion of the host vehicle on the roadway may be affected by a varying number proximate vehicles at different times. Thus, a fixed number of selected elements may be redundant or insufficient. Accordingly, reinforcement learning (RL) may be applied with hard attention so as not to enforce any constraints on the number of elements for forecasting. Since the selected information may be still at different levels of importance or influence, the soft attention acts as a ranking mechanism to further discriminate relative importance.

Furthermore, the ranked information may be employed to generate motion predictions, which in turn provide informative and stable rewards based performance metrics. During a training phase, the model components, such as the hard attention module and the soft attention module, are optimized alternatively. The alternating training strategy involving both reinforcement learning and a gradient based back-propagation to improve the modules alternatively.

### Definitions

The following includes definitions of selected terms employed herein. The definitions include various examples and/or forms of components that fall within the scope of a term and that may be used for implementation. The examples are not intended to be limiting. Furthermore, the components discussed herein, may be combined, omitted, or organized with other components or into different architectures.

“Agent” as used herein may be a biological being or biological being propelled machine that moves through or manipulates an environment. Exemplary agents may include, but are not limited to, humans, vehicles driven by humans, or other machines operated, at least in part, by a human. Alternatively, the agent may be a self-propelled machine that moves through or manipulates the environment. Exemplary agents may include, but are not limited to, robots, vehicles, or other self-propelled machines, such as, an autonomous or semi-autonomous vehicle.

“Bus,” as used herein, refers to an interconnected architecture that is operably connected to other computer components inside a computer or between computers. The bus may transfer data between the computer components. The bus may be a memory bus, a memory processor, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect network (LIN), among others.

“Component,” as used herein, refers to a computer-related entity (e.g., hardware, firmware, instructions in execution, combinations thereof). Computer components may include, for example, a process running on a processor, a processor, an object, an executable, a thread of execution, and a computer. A computer component(s) may reside within a process and/or thread. A computer component may be localized on one computer and/or may be distributed between multiple computers.

“Computer communication,” as used herein, refers to a communication between two or more communicating devices (e.g., computer, personal digital assistant, cellular telephone, network device, vehicle, vehicle computing device, infrastructure device, roadside equipment) and may be, for example, a network transfer, a data transfer, a file transfer, an applet transfer, an email, a hypertext transfer protocol (HTTP) transfer, and so on. A computer communication may occur across any type of wired or wireless system and/or network having any type of configuration, for example, a local area network (LAN), a personal area network (PAN), a wireless personal area network (WPAN), a wireless network (WAN), a wide area network (WAN), a metropolitan area network (MAN), a virtual private network (VPN), a cellular network, a token ring network, a point-to-point network, an ad hoc network, a mobile ad hoc network, a vehicular ad hoc network (VANET), a vehicle-to-vehicle (V2V) network, a vehicle-to-everything (V2X) network, a vehicle-to-infrastructure (V2I) network, among others. Computer communication may utilize any type of wired, wireless, or network communication protocol including, but not limited to, Ethernet (e.g., IEEE 802.3), WiFi (e.g., IEEE 802.11), communications access for land mobiles (CALM), WiMax, Bluetooth, Zigbee, ultra-wideband (UWAB), multiple-input and multiple-output (MIMO), telecommunications and/or cellular network communication (e.g., SMS, MMS, 3G, 4G, LTE, 5G, GSM, CDMA, WAVE), satellite, dedicated short range communication (DSRC), among others.

“Communication interface” as used herein may include input and/or output devices for receiving input and/or devices for outputting data. The input and/or output may be for controlling different vehicle features, which include various vehicle components, systems, and subsystems. Specifically, the term “input device” includes, but is not limited to: keyboard, microphones, pointing and selection devices, cameras, imaging devices, video cards, displays, push buttons, rotary knobs, and the like. The term “input device” additionally includes graphical input controls that take place within a user interface which may be displayed by various types of mechanisms such as software and hardware-based controls, interfaces, touch screens, touch pads or plug and play devices. An “output device” includes, but is not limited to, display devices, and other devices for outputting information and functions.

“Computer-readable medium,” as used herein, refers to a non-transitory medium that stores instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device may read.

“Database,” as used herein, is used to refer to a table. In other examples, “database” may be used to refer to a set of tables. In still other examples, “database” may refer to a set of data stores and methods for accessing and/or manipulating those data stores. In one embodiment, a database may be stored, for example, at a disk, data store, and/or a memory. A database may be stored locally or remotely and accessed via a network.

“Data store,” as used herein may be, for example, a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD ROM). The disk may store an operating system that controls or allocates resources of a computing device.

“Display,” as used herein may include, but is not limited to, LED display panels, LCD display panels, CRT display, touch screen displays, among others, that often display information. The display may receive input (e.g., touch input, keyboard input, input from various other input devices, etc.) from a user. The display may be accessible through various devices, for example, though a remote system. The display may also be physically located on a portable device, mobility device, or host.

“Logic circuitry,” as used herein, includes, but is not limited to, hardware, firmware, a non-transitory computer readable medium that stores instructions, instructions in execution on a machine, and/or to cause (e.g., execute) an action(s) from another logic circuitry, module, method and/or system. Logic circuitry may include and/or be a part of a processor controlled by an algorithm, a discrete logic (e.g., ASIC), an analog circuit, a digital circuit, a programmed logic device, a memory device containing instructions, and so on. Logic may include one or more gates, combinations of gates, or other circuit components. Where multiple logics are described, it may be possible to incorporate the multiple logics into one physical logic. Similarly, where a single logic is described, it may be possible to distribute that single logic between multiple physical logics.

“Memory,” as used herein may include volatile memory and/or nonvolatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

“Module,” as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module may also include logic, a software-controlled microprocessor, a discrete logic circuit, an analog circuit, a digital circuit, a programmed logic device, a memory device containing executing instructions, logic gates, a combination of gates, and/or other circuit components. Multiple modules may be combined into one module and single modules may be distributed among multiple modules.

“Operable connection,” or a connection by which entities are “operably connected,” is one in which signals, physical communications, and/or logical communications may be sent and/or received. An operable connection may include a wireless interface, firmware interface, a physical interface, a data interface, and/or an electrical interface.

“Portable device,” as used herein, is a computing device typically having a display screen with user input (e.g., touch, keyboard) and a processor for computing. Portable devices include, but are not limited to, handheld devices, mobile devices, smart phones, laptops, tablets, e-readers, smart speakers. In some embodiments, a “portable device” could refer to a remote device that includes a processor for computing and/or a communication interface for receiving and transmitting data remotely.

“Processor,” as used herein, processes signals and performs general computing and arithmetic functions. Signals processed by the processor may include digital signals, data signals, computer instructions, processor instructions, messages, a bit, a bit stream, that may be received, transmitted and/or detected. Generally, the processor may be a variety of various processors including multiple single and multicore processors and co-processors and other multiple single and multicore processor and co-processor architectures. The processor may include logic circuitry to execute actions and/or algorithms. The processor may also include any number of modules for performing instructions, tasks, or executables.

“Vehicle,” as used herein, refers to any moving vehicle that is capable of carrying one or more users and is powered by any form of energy. The term “vehicle” includes, but is not limited to cars, trucks, vans, minivans, SUVs, motorcycles, scooters, boats, go-karts, amusement ride cars, rail transport, personal watercraft, and aircraft. In some cases, a motor vehicle includes one or more engines. Further, the term “vehicle” may refer to an electric vehicle (EV) that is capable of carrying one or more users and is powered entirely or partially by one or more electric motors powered by an electric battery. The EV may include battery electric vehicles (BEV) and plug-in hybrid electric vehicles (PHEV). The term “vehicle” may also refer to an autonomous vehicle and/or self-driving vehicle powered by any form of energy. The autonomous vehicle may carry one or more users. Further, the term “vehicle” may include vehicles that are automated or non-automated with pre-determined paths or free-moving vehicles.

“Vehicle system,” as used herein may include, but is not limited to, any automatic or manual systems that may be used to enhance the vehicle, driving, and/or safety. Exemplary vehicle systems include, but are not limited to: an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a steering system, a transmission system, brake pedal systems, an electronic power steering system, visual devices (e.g., camera systems, proximity sensor systems), a climate control system, a monitoring system, a passenger detection system, a vehicle suspension system, a vehicle seat configuration system, a vehicle cabin lighting system, an audio system, a sensory system, an interior or exterior camera system among others.

### I. System Overview

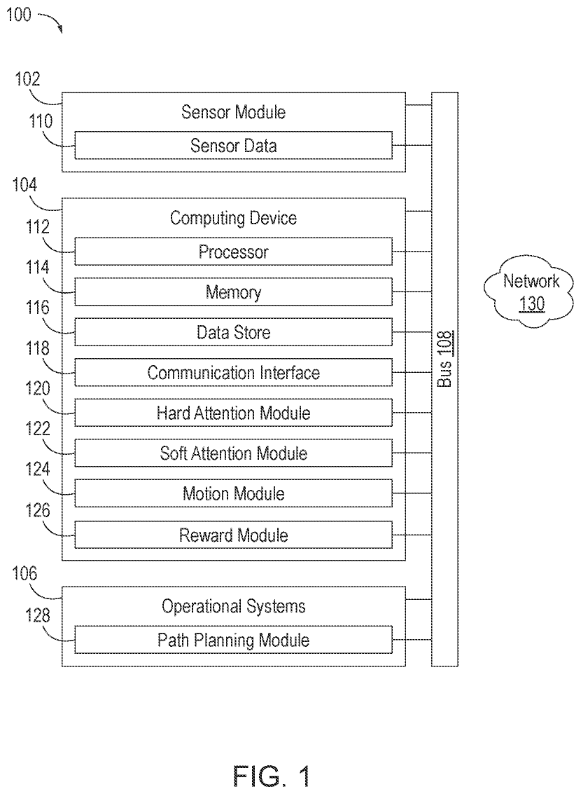

Referring now to the drawings, the drawings are for purposes of illustrating one or more exemplary embodiments and not for purposes of limiting the same. FIG. 1 is an exemplary component diagram of an operating environment 100 for reinforced hybrid attention for motion forecasting, according to one aspect. The operating environment 100 includes a sensor module 102, a computing device 104, and operational systems 106 interconnected by a bus 108. The components of the operating environment 100, as well as the components of other systems, hardware architectures, and software architectures discussed herein, may be combined, omitted, or organized into different architectures for various embodiments.

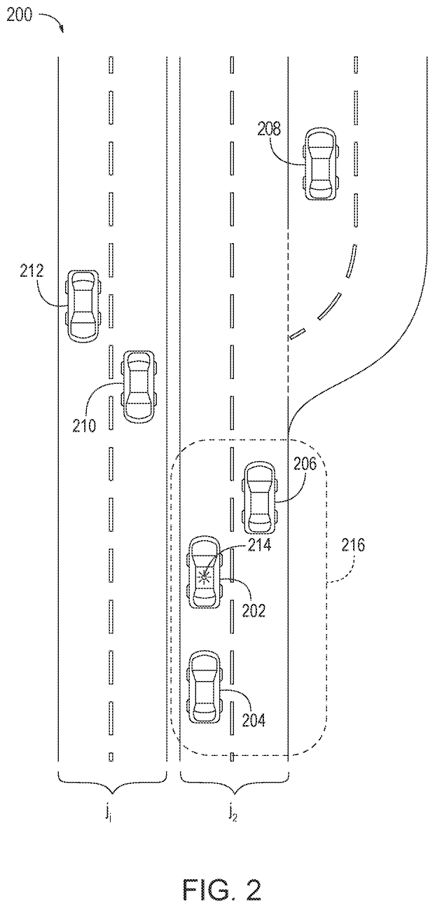

The computing device 104 may be implemented with a device or remotely stored. For example, with respect to a vehicle embodiment, the computing device 104 may be implemented as part of a telematics unit, a head unit, a navigation unit, an infotainment unit, an electronic control unit of a host vehicle 202 in a roadway 200 shown in FIG. 2.

In other embodiments, the components and functions of the computing device 104 may be implemented, for example, with other devices (e.g., a portable device) or another device connected via a network (e.g., a network 130). The computing device 104 may be capable of providing wired or wireless computer communications utilizing various protocols to send/receive electronic signals internally to/from components of the operating environment 100. Additionally, the computing device 104 may be operably connected for internal computer communication via the bus 108 (e.g., a Controller Area Network (CAN) or a Local Interconnect Network (LIN) protocol bus) to facilitate data input and output between the computing device 104 and the components of the operating environment 100.

The computing device 104 includes a processor 112, a memory 114, a data store 116, and a communication interface 118, which are each operably connected for computer communication via a bus 108 and/or other wired and wireless technologies. The communication interface 118 provides software and hardware to facilitate data input and output between the components of the computing device 104 and other components, networks, and data sources, which will be described herein.

Additionally, the computing device 104 includes a hard attention module 120, a soft attention module 122, and a motion module 124, for reinforced hybrid attention facilitated by the components of the operating environment 100. The computing device 104 may also include a reward module 126 for generating rewards. In one embodiment, the hard attention module 120, the soft attention module 122, the motion module 124, and the reward module 126 may be included with the processor 112. The hard attention module 120, the soft attention module 122, the motion module 124, and the reward module 126 may be or include artificial neural networks that act as a framework for machine learning, including deep learning, reinforcement learning, etc. In some embodiments, one or more of the modules may include LSTM networks (e.g., E-LSTM, G-LSTM, etc.).

The computing device 104 is also operably connected for computer communication (e.g., via the bus 108 and/or the communications interface 118) to one or more operational systems 106. The operational systems 106 may include, but are not limited to, any automatic or manual systems that may be used to enhance the systems and methods. The operational systems 106 include a path planning module 128. The path planning module 128 monitors, analyses, and/or operates the device, to some degree. For example, the path planning module 128 may store, calculate, and provide directional information and facilitates features like vectoring and obstacle avoidance among others. The operational systems 106 may dependent on the implementation.

The sensor module 102 provides and/or senses information associated with a device, the operating environment 100, the operational systems 106, physical environment, biological entities, agents, etc. The sensor module 102 may include, but is not limited to, environmental sensors, vehicle speed sensors, accelerator pedal sensors, brake sensors, wheel sensors, among others. In some embodiments, the sensor module 102 is incorporated with the operational systems 106.

Accordingly, the sensor module 102 is operable to sense a measurement of sensor data 110 associated with the device, the operating environment 100, the device environment, and/or the operational systems 106 and generate a data signal indicating said measurement of the sensor data 110. These data signals may be converted into other data formats (e.g., numerical) and/or used by the sensor module 102, the computing device 104, and/or the operational systems 106 to generate other data metrics and parameters. It is understood that the sensors may be any type of sensor, for example, acoustic, electric, environmental, optical, imaging, light, pressure, force, thermal, temperature, proximity, among others. The sensor data 110 may include spatio-temporal historical observations.

The sensor module 102, the computing device 104, and/or the operational systems 106 are also operatively connected for computer communication to the network 130. The network 130 is, for example, a data network, the Internet, a wide area network (WAN) or a local area (LAN) network. The network 130 serves as a communication medium to various remote devices (e.g., databases, web servers, remote servers, application servers, intermediary servers, client machines, other portable devices).

### II. Methods for Curious Agents in Uncertain Environments

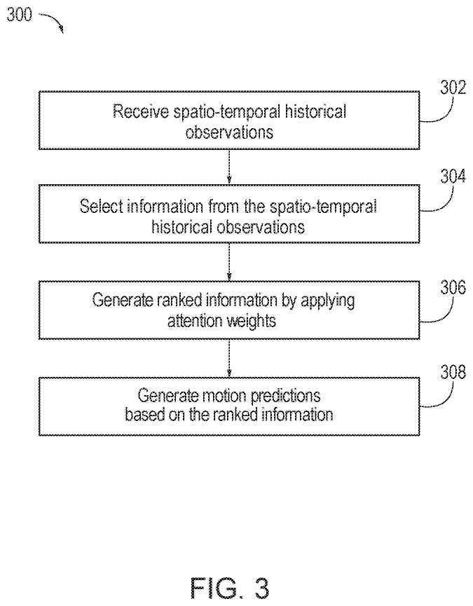

Referring now to FIG. 3, a method 300 for reinforced hybrid attention for motion forecasting will now be described according to an exemplary embodiment. FIG. 3 will be described with reference to FIGS. 1 and 2. For simplicity, the method 300 will be described as a sequence of blocks, but it is understood that the elements of the method 300 may be organized into different architectures, elements, stages, and/or processes.

At block 302 of the method 300, the sensor module 102 receives spatio-temporal historical observations associated at least one element in an environment. The type of element may be based on the context of the embodiment. For example, in a roadway scenario, elements may include a host vehicle as well as other vehicles on the roadway, roadway infrastructure (e.g., traffic lights, traffic signs, pavement markings, etc.), obstacles, etc. In a skeletal scenario the elements may include limbs, joints, etc.

Turning to a vehicular embodiment, a host vehicle 202 may be traveling on a roadway 200. The roadway 200 may be any type of road, highway, freeway, or travel route. In FIG. 2, the roadway 200 includes a freeway having two lanes for traveling in a first longitudinal direction, j₁, and two lanes for traveling in a second longitudinal direction, j₂. The two lanes for traveling in the second longitudinal direction, j₂, also include an adjacent off-ramp, for traveling in the second longitudinal direction, j₂. However, it is understood that the roadway 200 may have various configurations not shown in FIG. 2 and may have any number of lanes.

The host vehicle 202 may share the roadway 200 with a number of vehicles including vehicles 204-212. Each of the vehicles may collect spatio-temporal historical observations. For example, the host vehicle 202 may receive spatio-temporal historical observations about the roadway 200 via host vehicle sensors, such as a host vehicle sensor 214. The host vehicle sensor 214 may include, but is not limited to, image sensors, such as cameras, optical sensors, radio sensors, etc. mounted to the interior or exterior of the host vehicle 202 and light sensors, such as light detection and ranging (LiDAR) sensors, radar, laser sensors etc. mounted to the exterior of the host vehicle 202. Further, the host vehicle sensor 214 may include sensors external to the host vehicle 202 (accessed, for example, via the network 130), for example, external cameras, radar and laser sensors on other vehicles in a vehicle-to-vehicle network, street cameras, surveillance cameras, among others. The spatio-temporal historical observations may be received as sensor data 110 at the sensor module 102 from the host vehicle sensor 214. The vehicles 204-212 may have similar vehicle sensors for collecting spatio-temporal historical observations as sensor data, such that each of the vehicles collects spatio-temporal historical observations.

The spatio-temporal historical observations may include the movement, identity, location, position, characteristics, etc. of the elements in the environment. The spatio-temporal historical observations may also include information able the environment itself, such as location and identification of features of the physical environment. For example, in the roadway scenario the spatio-temporal historical observations may include kinematics of vehicles (e.g., position, velocity, acceleration, trajectory, etc.), the current state of traffic signals (e.g., illuminated, flashing, etc.), the location of obstacles, etc.

While the vehicular embodiment includes multiple agents, such as the vehicles 204-212, the spatio-temporal historical observations may also be received for a single agent, such as human in motion. Because the spatio-temporal historical observations may be received for multiple domains the problem formulation may be given in a general way, such as a dynamic multivariate system:

X_{t+1:t+T}_{_{f}}·=f(X_{t-T}_{ₕ}_{+1:t,}C)

where Xₜ={xₜⁱ, i=1, N} denotes the system state at time t and C={cⁱ, i=1, N} denotes optional context information or external factors. N is the total number of elements which have a specific meaning in different domains. The dynamic multivariate system may be used to approximate the conditional distribution p(X_{t+1:t+T}_{_{f}}|X_{t-T}_{ₕ}_{+1:t}C), where Tₕ and T_{f} denote the history and prediction horizon.

For a multi-agent interacting system, such as the vehicular embodiment shown in FIG. 2, the elements refer to the involved homogeneous and/or the vehicles 204-212. In some embodiments, the sensor module 102 may additionally or alternatively receive spatio-temporal historical observations from one or more of the vehicles 204-212.

As another example, for a multivariate time series such as human motions, the elements refer to a set of human skeletons, where a state of the spatio-temporal historical observations may include joint coordinates or relative angles. In the skeletal scenario, spatio-temporal historical observations may include kinematics of the joints and/or limbs (e.g., position, trajectory, relative angle between elements, etc.)

Because spatio-temporal historical observations are shared between elements, a multi-agent system with N entities is represented as a fully connected (FC) graph [symbol] =(V, ε), where V={vᵢ, i=1, N} and ε={eᵢⱼ, i, j=1,N}. vᵢ denotes node i's attribute and eᵢⱼ denotes the edge attribute from sender node j to receiver node i. The node attribute includes a self-attribute to store the individual information, a social-attribute to store other entities' information, and a context-attribute to include the agent's context information. More formally, vᵢ^{self}=fₛ^{m}(x_{t-T}_{ₕ}_{+1:t}ⁱ), v^{neighbor}=fₙ^{m}(x_{t-T}_{ₕ}_{+1:t}ⁱ), vᵢ^{context}=f_{c} (cⁱ), where m∈{1, . . . M}, M is number of agent types. fₛ^{m} and fₙ^{m} are state embedding functions, and f_{c} is context embedding function. Different state embedding functions corresponding to certain agent types are applied to heterogeneous agents. In this manner, agents, such as the host vehicle 202 and other vehicles 204-212, may share spatio-temporal historical observations. For example, vehicle 204-212 in communication range with the host vehicle 202 may communicate the spatio-temporal historical observations. The sensor module 102 may receive spatio-temporal historical observations from the host vehicle 202 and other vehicles 204-212 via the bus 108, the communication interface 118, and the network 130, among others.

For example, vehicles may communicate via a transceiver (not shown). The transceiver may be a radio frequency (RF) transceiver may be used to receive and transmit information to and from the sensor module 102. In some embodiments, the computing device 104 may receive and transmit information to and from the sensor module 102 including, but not limited to, vehicle data, traffic data, road data, curb data, vehicle location and heading data, high-traffic event schedules, weather data, or other transport related data. In some embodiments, the sensor module 102 may be linked to multiple vehicles, other entities, traffic infrastructures, and/or devices through a network connection, such as the network 130, the roadside equipment, and/or other network connections. As another example, vehicles may communicate with the sensor module 102 through an internet cloud and is capable of utilizing a GSM, GPRS, Wi-Fi, WiMAX, or LTE wireless connection to send and receive one or more of sensor data 110, signals, data, etc. directly through the cloud.

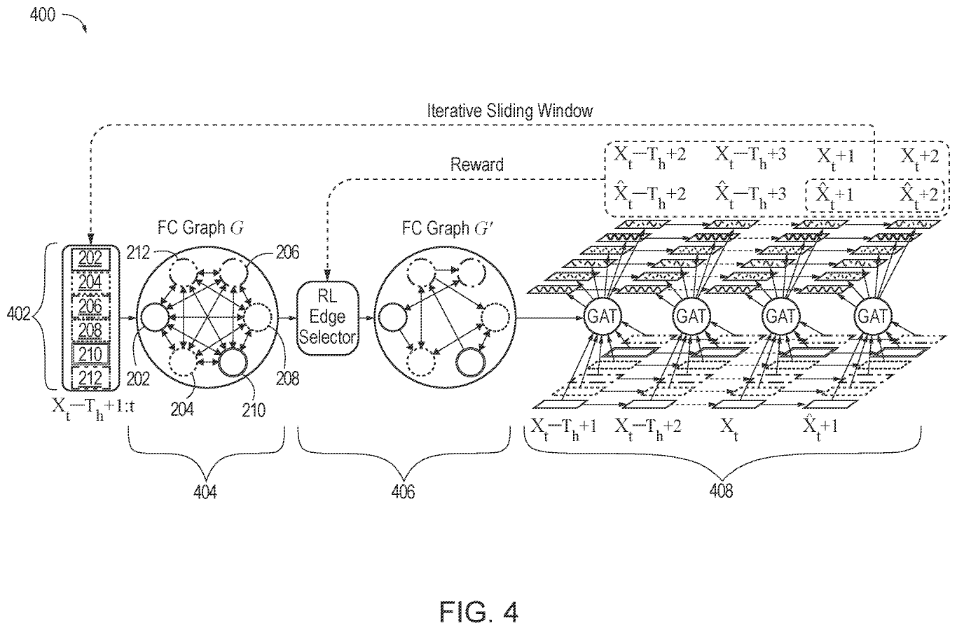

Since different relations within the system may lead to similar observations, multiple agents may contribute to a spatio-temporal historical observation grouping 402, as shown in FIG. 4. For example, all of the spatio-temporal historical observations from each of the vehicles 202-212 may be included in the spatio-temporal historical observation grouping 402. In one embodiment, a round of message passing may be performed to collect the spatio-temporal historical observations across the FC graph [symbol] also shown in FIG. 4. The message passing by across the FC graph [symbol] may be given by:

$${α}_{ij} = \frac{exp ( M L P ( [ {v}_{i}^{se 1 f} ‖ {v}_{j}^{n e i g h b o r} ] ) )}{{\sum }_{k {ϵ𝒩}_{i}} exp ( MLP ( [ {v}_{i}^{se 1 f} ‖ {v}_{k}^{n e i g h b o r} ] ) )} , \\ {v}_{i}^{s o cial} = f v ( {\sum }_{j {ϵ𝒩}_{i}} {α}_{ij} {v}_{j}^{n e i g h b o r} ) ,$$

where fᵥ is the social attribute update function and ∥ denotes the concatenation operation. [symbol] denotes the set of one-hop neighbors of node i. MLP refers to multi-layer perceptron. The complete node attribute is

vᵢ=f_{enc}([vᵢ^{self},vᵢ^{social},vᵢ^{context}]).

Returning to FIG. 3, at block 304, the method 300 includes the hard attention module 120 selecting information from the spatio-temporal historical observations associated with the at least one element based on a reinforcement learning model. The hard attention module 120 serves as a key information selector, which takes the complete spatio-temporal historical observations as input and identifying relevant observations from the spatio-temporal historical observations. Additionally, the hard attention module 120 may discard the remaining spatio-temporal historical observations. In this manner, the hard attention module 120 may select a subset of information from the spatio-temporal historical observations.

In the context of multi-agent system, the hard attention module 120 identifies influencing factors when predicting the motions of a certain agent. Suppose that motions of the host vehicle 202 are being forecasted. The hard attention module 120 may identify that vehicle 204 and vehicle 206 within a conflict zone 216 are proximate vehicles, and therefore influence the motions of the host vehicle.

As one example, the existence of each edge in the FC graph may be asserted based on the spatio-temporal historical observations so that redundant information is discarded in the prediction. Accordingly, the edges represent the selected information from the spatio-temporal historical observations associated with the at least one element based on a reinforcement learning model.

The selection of edges feed into a reinforcement learning framework. The observation O of RL-agent at RL step η (≤T_{RL}) includes a pair of node attributes vᵢ and vⱼ as well as the current edge selection status sᵢⱼ (0: retained or 1: discarded). T_{RL} is the upper bound of RL-steps. The observation [symbol] _{η}is obtained by [symbol] _{η}=[vᵢ, vⱼ, s_{ij,η}]. The dimension of [symbol] _{η} may only depend on the dimension of node attributes, which enables the applicability to the systems with varying numbers of entities. The policy network of RL-agent takes the observation [symbol] _{η} as input and decides the action at the current RL-step.

There are two possible actions for the RL agent: “staying the same” (action: 0) and “changing to the opposite” (action: 1). At each RL-step, the RL-agent makes decision for each edge in the FC graph. The policy may be written as a=π(O). Constraints are not enforced on the selection of edges, such that a number of elements of the at least one element is unbounded so there is no lower bound or upper bound on the number of selected edges. The actions of RL-agent may change the topology of the inferred graph [symbol] ′ after each RL-step, which further influence the soft attention module 122. Therefore, rather than all of the information from each of the spatio-temporal historical observations being selected, the hard attention module 120 selects information from the spatio-temporal historical observation grouping 402. The selection may be based on a reinforcement learning model. In particular, the reinforcement learning model may be trained to discriminate information of the spatio-temporal historical observation grouping 402

The reinforcement learning model may be trained to determine the relevancy of the information of the spatio-temporal historical observations based on the rewards. In general, the reward indicates how good the action taken by the RL-agent is with respect to the current situation. Here, the reward may be designed to indicate the performance of motion forecasting in various aspects. The acquisition of high rewards depends on the collaboration of all the modules in the framework.

In some embodiments, the reward consists of three parts: regular reward R_{reg}, improvement reward Rᵢₘₚ and stimulation/punishment Rₛₜᵢ/Rₚᵤₙ. More specifically, the regular reward may be the negative mean squared error of future predictions calculated by:

$${R}_{r e g , η} = - \frac{1}{N} {\sum }_{i = 1}^{N} {\sum }_{{t}^{′} = t + 1}^{t + {T}_{f}} {‖ {x}_{t}^{i} , - {\hat{x}}_{{t}^{′} , η}^{i} , η ‖}^{2}$$

The improvement reward encourages the decrease of prediction error via applying a sin function to the error change between consecutive RL-steps, which is obtained by:

R_{imp,η}=sin(R_{reg,72}−R_{reg,η-1}).

The reason of applying a sin function instead of directly using the raw improvement is to avoid reward vanishing when improvement becomes smaller towards convergence. The stimulation/punishment is applied when there is a large improvement or deterioration in terms of a certain metric, which is given by:

R_{sti,η}=Ωₛ,R_{pun,η}=−Ωₚ

where Ωₛ and Ωₚ are manually defined positive constants. These rewards depend on the metrics in specific domains. Then the whole reward is calculated by:

R_{η}=R_{reg,η}+βᵢₘₚR_{imp,η}+βₛₜᵢR_{sti,η} [symbol] (sti)+βₚᵤₙR_{pun,η} [symbol] (pun)

where βᵢₘₚ,βpₛₜᵢ, and βₚᵤₙ are hyperparameters and [symbol] (·) is an indicator function to indicate the occurrence of large improvement or deterioration.

At block 306 of the method 300 the soft attention module 122 generating ranked information by applying attention weights to the selected information. For example, after the hard attention module 120 selects the information, illustrated in the graphical representation 400 of the FIG. 4 as edges, the soft attention module 122 is applied over the inferred graph [symbol] ′ to further determine the relative significance of the selected information at each time step. The relative significance is given by the attention weights.

Time step t is taken as an example to illustrate the soft attention module 122. In order to avoid confusion on notation with the hard attention module 120, here i-th node attribute at time t is denoted as:

v̅_{i,t}=[v̅_{i,t}^{self},v̅_{i,t}^{social},vᵢ^{context}],

where the context attribute vᵢ^{context} is discussed above, and the social attribute v̅_{i,t}^{social} is calculated by the graph soft attention mechanism as follows:

$${\overline{α}}_{ij}^{t} = \frac{exp ( M L P ( [ {\overline{v}}_{i , t}^{self} ‖ {\overline{v}}_{j , t}^{n e i g h b o r} ] ) )}{{\sum }_{k {ϵ𝒩}_{i}} exp ( M L P ( [ {\overline{v}}_{i , t}^{self} ‖ {\overline{v}}_{k , t}^{n e i g h b o r} ] ) )} , {\overline{v}}_{i , t}^{social} = {\overline{f}}_{v} ( {\sum }_{j ϵ {N}_{i}} exp {\overline{α}}_{ij}^{t} {\overline{v}}_{j , t}^{neighbor}$$

where α̅ᵢⱼ^{t} are learnable attention weights and the MLP is multilayer perceptron (MLP). In some embodiments, multi-head attention may also be used to stabilize training such that the hard attention module 120 and the soft attention module operate several times in parallel. Accordingly, the systems and methods described herein are directed to a hybrid model that uses both hard attention and soft attention to identify elements that are relevant object and features associated with the physical environment.

At block 308 of the method 300, the motion module 124 generates motion predictions based on the ranked information. The motion module 124 may therefore predict the motion based on the ranked information. In some embodiments, the motion module 124 includes two LSTM networks (E-LSTM/G-LSTM) with the soft graph attention in between. The E-LSTM takes in agent state information and outputs v̅_{i,t}^{self} at each time step, while the G-LSTM takes in the complete node attribute v̅_{i,t} and outputs the predicted change in state Δ\hat{x}ₜⁱ at the current time t, which is used to calculate the state \hat{x}ₜ₊₁ⁱ with the system model (e.g. discrete-time linear dynamics). More specifically at time t,

Embedding: v̅_{i,t}^{self}=E-LSTM^{s}(xₜⁱ;hₜ^{s,i})

v̅_{i,t}^{neighbor}=E-LSTMⁿ(xₜⁱ;hₜ^{n,i})

Generation: Δ\hat{x}ₜⁱ=G-LSTM(v̅_{i,t};\tilde{h}ₜⁱ)

\hat{x}=f_{system}(xₜⁱ,Δ\hat{x}ₜⁱ)

where hₜ^{s,i}, hₜ^{n,i}, and \tilde{h}ₜⁱ are the hidden states of E-LSTM and G-LSTM respectively. In some embodiments, the generation process may be divided into two stages: burn-in stage (from t−Tₕ+1 to t) and prediction stage (from t+1 to t+T_{f}). At burn-in stage, the true state is fed into E-LSTM while at prediction stage, the last prediction is fed instead. If the topology of the inferred graph [symbol] ′ is assumed to remain static over time, one-shot generation may be used to obtain the complete future trajectory as the motion prediction. Otherwise, the trajectory segment within a certain future horizon τ<T_{f} may be generated first, and push the predicted segment into the observations. This process may be iteratively propagated to generate the whole trajectory over the future horizon. Accordingly, motion forecasting may be performed to generate motion predictions for an element, such as the host vehicle 202, based on the ranked information. The motion forecasting may be used facilitate motion planning. For example, the path planning module 128 may use the motion predictions to plan a path for the host vehicle 202.

Turning to FIG. 4, an exemplary graph representation 400 is shown. The graphical representation 400 includes a graph message passing (GMP) module 404, a RL based hard attention (RL-HA) module 406, and a soft graphical attention based motion generator (SGA-MG) module 408 that correspond to the modules described with respect to the operating environment 100. For example, the sensor module 102 may include the GMP module 404 to collect the spatio-temporal historical observation grouping 402. The hard attention module 120 may include the RL-HA module 406. Likewise, the soft attention module 122 may include SGA-MG module 408. the GMP module 404, the RL-HA module 406, and the SGA-MG module 408 cooperate closely to improve the final prediction performance for the motion module 124.

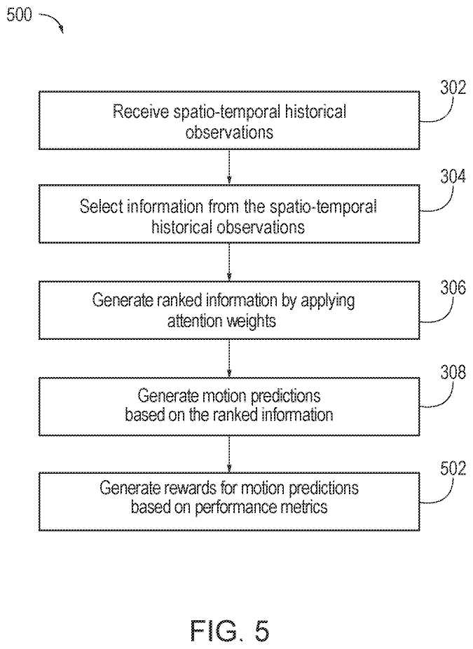

Referring now to FIG. 5, a method 500 for reinforced hybrid attention for motion forecasting will now be described according to another exemplary embodiment. FIG. 5 will also be described with reference to FIGS. 3 and 4. For simplicity, the method 500 will be described as a sequence of blocks. Blocks of the method 500 corresponding to blocks of the method 300 operate in a similar manner as described with respect to FIG. 3. The blocks of FIG. 5 however will be described through the lens of the exemplary graph representation 400 of FIG. 4 and the components therein.

In such an embodiment, for the prediction of a certain target entity, at block 302 of the method 500 the GMP module 404 receives the spatio-temporal historical observations from other entities across graph [symbol] . At block 304 of the method 500, information is selected from the spatio-temporal historical observations. For example, the RL-HA 406 discriminates the key relevant elements from the complete spatio-temporal historical observations. At block 306 of the method 500, the selected key information is ranked. For example, the selected information is provided to the SGA-MG module 408 with an inferred relation graph [symbol] ′ having selected edges, which naturally incorporates relational inductive biases. The SGA-MG 408 uses soft attention weights to rank the relative importance of the selected information. At block 308 of the method 500, the motion module 124 generates future trajectories.

At block 502 of the method 500, a reward module 126 generates rewards for future motion hypotheses based on performance metrics. The reward indicates how good the prediction was based on the outcome. For example, the prediction together with the ground truth provides rewards to the RL-HA 406 during the training phase to guide the improvement of the RL edge selector. The GMP module 404 is pre-trained to collect contextual information across the whole graph. The SGA-MG module 408 is pre-trained with a fully connected topology in order to improve training efficiency and stability as well as to enable informative initial reward.

The GMP module 404, RL-HA module 406, and SGA-MG module 408 may be trained individually or in an alternating strategy. For example, in order to enable informative initial reward for the RL-HA module, the SGA-MG module 408 may be trained with a fully connected topology. The model architecture may be the same as shown in FIG. 4 with a GAT is applied to a fully connected graph. The loss function may be a mean squared error loss, which is calculated as:

$${L}_{G M P} = \frac{1}{N {T}_{h}} {\sum }_{i = 1}^{N} {\sum }_{{t}^{′} = t - {T}_{h} + 1}^{t} {‖ {x}_{t}^{i} , - {x}_{{t}^{′}}^{i} ‖}^{2} .$$

After convergence, the parameters of the GMP module 404 are saved and discard those of the decoder, since the GMP module 404 may only be used in the following formal-training stage. In order to enable informative initial reward for the RL-HA module 406, the SGA-MG module 408 may be pre-trained with a fully connected topology. The loss function is a standard mean squared error loss, which is calculated as:

$${L}_{SGA - MG} = \frac{1}{N {T}_{f}} {\sum }_{i = 1}^{N} {\sum }_{{t}^{′} = t + 1}^{t + {T}_{f}} {‖ {x}_{t}^{i} , - {\hat{x}}_{{t}^{′}}^{i} ‖}^{2} .$$

In the formal-training stage, the RL-HA module 406 and fine tune the SGA-MG module 408. The complete history motions may be denoted as X_{t-T}_{ₕ}_{+1:t} and the future motions as X_{t+1:t+T}_{_{f}}. It may be assumed that Tₕ>Tₛ+T_{f} where Tₛ is the length of the motion segments used to compute attention weights.

An auto-encoder structure may be used to train an encoding function that may extract the contextual information from the complete history motion sequence. More formally, the auto-encoder may be written as:

Z=Encoding(X_{t-T}_{ₕ}_{1:t})

\hat{X}_{t-T}_{ₕ}_{+1:t}=Decoding(Z)

where Encoding and Decoding functions are neural networks, as described above. The loss function of training the auto-encoder may be the standard mean squared error reconstruction loss, which is calculated by:

$$MSE = \frac{1}{{JT}_{h}} {\sum }_{j = 1}^{J} {\sum }_{{t}^{′} = t - {T}_{h} + 1}^{t} {‖ {x}_{t}^{j} , - {\hat{x}}_{{t}^{′}}^{j} ‖}^{2}$$

Here, J may be the number of relative angles between joints in a skeleton in a human agent embodiment.

In the formal-training stage, the RL-HA module 406 and the SGA-MG module 408 may be alternatively trained. More specifically, the motion history X_{t-T}_{ₕ}_{+1:t} may be divided into Tₕ−Tₛ−T_{f}+1 segments {X_{i:i+τ}_{ₛ}_{+τ}_{_{f+}}₋₁}_{i=t-τ}_{ₕ}₊₁^{t-T}^{ₛ}^{-T}^{_{f}}⁺¹, each of which contains Tₛ+T_{f} consecutive frames of human poses. The SGA-MG module 408 exploits the past Tₛ frames to predict the future T_{f} frames. The first Tₛ frames of each segment is used as a key, and the whole segment is then the corresponding value. The query is defined as the latest segment X_{t-T}_{ₛ}_{+1:t}.

For example, in the domain of forecasting human skeleton motions, the RL-HA module 406 is expected to select the key history motion segments for the current prediction based on the latest observation segment. Then, the SGA-MG module 408 will further rank the relative importance of the selected key segments, which is employed by the motion module 124 to generate future predictions.

The observation O of RL-agent at RL-step η (≤T_{RL}) includes a tuple of key, query, contextual information Z as well as the current segment selection status sᵢ (0: “retained” or 1: “discarded”). T_{RL} is the upper bound of RL-steps. The observation O_{η} is obtained by

O_{η}=[fₖ(X_{i:i+T}_{ₛ}·−1),f_{q}(X_{t-T}_{ₛ}+1:t),Z,s_{i,η}]

where fₖ and f_{q} are mapping functions modeled by neural networks. The dimension of O_{η} may only depend on the dimensions of key, query and contextual information, which enables the applicability to the scenarios with varying numbers of history motion segments. The policy network of RL-agent takes the observation O_{η} as input and decides the action at each RL-step.

There are two possible actions for the RL-agent: “staying the same” (action 0) and “changing to the opposite” (action 1). At each RL-step, the RL-agent makes decision for each history motion segment. The policy may be written as a=π(OAs discussed above, constraints are not enforced on the selection of motion segments, i.e. there is no lower/upper bound on the number of selected segments. The actions of RL-agent may change the key motion segments after each RL-step, which further influences the SGA-MG module 408.

Rewards: The reward consists of two parts: regular reward R_{reg} and improvement reward Rᵢₘₚ. More specifically, the regular reward is the negative mean squared error of future predictions calculated by

$${R}_{r e g , η} = - \frac{1}{J} {\sum }_{j = 1}^{J} {\sum }_{{t}^{′} = t + 1}^{t + {T}_{f}} {‖ {x}_{t}^{j} , - {\hat{x}}_{{t}^{′} , η}^{j} ‖}^{2} .$$

The improvement reward encourages the decrease of prediction error via applying a sin function to the error change between consecutive RL-steps, which is obtained by:

R_{imp,η}=sign(R_{reg,η}−R_{reg,η-1}).

The whole reward may be obtained by R_{η}=R_{reg,η}+βᵢₘₚR_{reg,η} where βᵢₘₚ is a hyper parameter. Accordingly the RL-HA module 406 and the SGA-MG module 408 may be optimized using an alternating strategy. Thus, a double-stage training pipeline with an alternating training strategy may be used to improve different modules in the framework, such as the operating environment 100 and/or the exemplary graph representation 400. The general framework provides a graph-based model for multi-agent trajectory forecasting that may be used in various domains such as a skeletal embodiment or a vehicular embodiment.

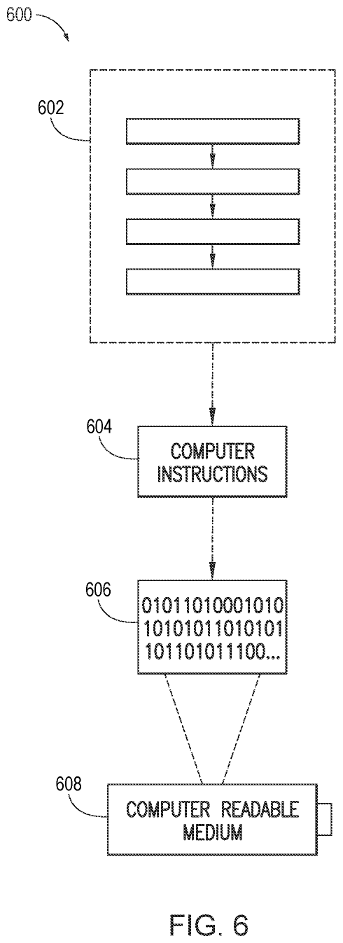

Still another aspect involves a computer-readable medium including processor-executable instructions configured to implement one aspect of the techniques presented herein. An aspect of a computer-readable medium or a computer-readable device devised in these ways is illustrated in FIG. 6, wherein an implementation 600 includes a computer-readable medium 608, such as a CD-R, DVD-R, flash drive, a platter of a hard disk drive, etc., on which is encoded computer-readable data 606. This encoded computer-readable data 606, such as binary data including a plurality of zero's and one's as shown in 606, in turn includes a set of processor-executable computer instructions 604 configured to operate according to one or more of the principles set forth herein. In this implementation 600, the processor-executable computer instructions 604 may be configured to perform a method 602, such as the method 300 of FIG. 3 and/or the method 500 of FIG. 5. In another aspect, the processor-executable computer instructions 604 may be configured to implement a system, such as the operating environment 100 of FIG. 1 and/or the framework shown in the graphical representation 400 of FIG. 4. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

The term “computer readable media” as used herein includes computer storage media. Computer storage media includes volatile and nonvolatile, removable and non-removable media implemented in any method or technology for storage of information such as computer readable instructions or other data. The memory 114 and the data store 116 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the sensor module 102, the computing device 104, and/or the operational systems.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Although the subject matter has been described in language specific to structural features or methodological acts, it is to be understood that the subject matter of the appended claims is not necessarily limited to the specific features or acts described above. Rather, the specific features and acts described above are disclosed as example aspects. Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that several of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A system for reinforced hybrid attention for motion forecasting, the system comprising:
a sensor module configured to receive spatio-temporal historical observations associated at least one element in an environment;
a hard attention module configured to select information from the spatio-temporal historical observations associated with the at least one element based on a reinforcement learning model;
a soft attention module configured to generate ranked information by applying attention weights to the selected information; and
a motion module configured to generate motion predictions based on the ranked information.

2. The system of claim 1, wherein a number of elements of the at least one element is unbounded.

3. The system of claim 1, further comprising a reward module configured to generate rewards for the motion predictions based on performance metrics of an action of an element.

4. The system of claim 3, wherein the reinforcement learning model determines relevancy of the information of the spatio-temporal historical observations based on the rewards.

5. The system of claim 1, wherein the system is trained with an alternating training strategy using both reinforcement learning model and gradient based back propagation.

6. The system of claim 1, wherein the environment is a roadway, and wherein the at least one element includes a plurality of agents traveling the roadway.

7. The system of claim 1, wherein the spatio-temporal historical observations are based on human skeleton motions of a human, and wherein the at least one element includes at least one joint of the human.

8. A computer-implemented method for reinforced hybrid attention for motion forecasting, the computer-implemented method comprising:
receiving spatio-temporal historical observations associated at least one element in an environment;
selecting information from the spatio-temporal historical observations associated with the at least one element based on a reinforcement learning model;
generating ranked information by applying attention weights to the selected information; and
generating motion predictions based on the ranked information.

9. The computer-implemented method of claim 8, wherein a number of elements of the at least one element is unbounded.

10. The computer-implemented method of claim 8, further comprising generating rewards for the motion predictions based on performance metrics of an action of an element.

11. The computer-implemented method of claim 10, wherein the reinforcement learning model determines relevancy of the information of the spatio-temporal historical observations based on the rewards.

12. The computer-implemented method of claim 8, wherein the environment is a roadway, and wherein the at least one element includes a plurality of agents traveling the roadway.

13. The computer-implemented method of claim 8, wherein the spatio-temporal historical observations are based on human skeleton motions of a human, and wherein the at least one element includes at least one joint of the human.

14. A non-transitory computer readable storage medium storing instructions that when executed by a computer having a processor to perform a method for reinforced hybrid attention for motion forecasting, the method comprising:
receiving spatio-temporal historical observations associated at least one element in an environment;
selecting information from the spatio-temporal historical observations associated with the at least one element based on a reinforcement learning model;
generating ranked information by applying attention weights to the selected information; and
generating motion predictions based on the ranked information.

15. The non-transitory computer readable storage medium of claim 14, wherein a number of elements of the at least one element is unbounded.

16. The non-transitory computer readable storage medium of claim 14, further comprising generating rewards for the motion predictions based on performance metrics of an action of an element.

17. The non-transitory computer readable storage medium of claim 16, wherein the reinforcement learning model determines relevancy of the information of the spatio-temporal historical observations based on the rewards.

18. The non-transitory computer readable storage medium of claim 14, wherein selecting the information from the spatio-temporal historical observations includes identifying relevant observations from the spatio-temporal historical observations and discarding remaining spatio-temporal historical observations.

19. The non-transitory computer readable storage medium of claim 14, wherein the environment is a roadway, and wherein the at least one element includes a plurality of agents traveling the roadway.

20. The non-transitory computer readable storage medium of claim 14, wherein the spatio-temporal historical observations are based on human skeleton motions of a human, and wherein the at least one element includes at least one joint of the human.
